(19) United States
(12) Patent Application Publication
(10) Pub. No.: US 2013/0073794 A1
(43) Pub. Date: Mar. 21, 2013

(54) MEMORY SYSTEM AND CONTROL METHOD THEREOF

(71) Applicant: Taro IWASHIRO, Yokohama-shi (JP)

(72) Inventor: Taro IWASHIRO, Yokohama-shi (JP)

(21) Appl. No.: 13/427,191

(22) Filed: Mar. 22, 2012

(30) Foreign Application Priority Data
Sep. 21, 2011 (JP) 2011-206105

(51) Int. Cl. G06F 12/00; G06F 1/32

(52) U.S. Cl. 711/103; 711/E12.008

(57) ABSTRACT

According to one embodiment, a memory system includes a storage unit including a buffer and a nonvolatile first memory, and a first controller which includes a processor and a volatile second memory, and in which the processor controls the storage unit based on data stored in the second memory, and issues a first command when switching from a normal state to a standby state. The memory system also includes a second controller which issues a second command for reading data from the first memory to the buffer, based on the first command, and issues a third command for reading the data from the buffer and storing the data in the second memory, when the first controller switches from the standby state to the normal state.

### CROSS-REFERENCE TO RELATED APPLICATIONS

This application is based upon and claims the benefit of priority from prior Japanese Patent Application No. 2011-206105, filed Sep. 21, 2011, the entire contents of which are incorporated herein by reference.

### FIELD

Embodiments described herein relate generally to a memory system and a control method thereof.

### BACKGROUND

Recently, a memory system is incorporated into a mobile apparatus such as a smartphone, and demands have arisen for low-power-consumption design of the memory system. In a standby state, therefore, partial power shutdown is performed for circuits to which no access is necessary. However, restoration from the standby state generally takes a long time, and this decreases the access performance of the memory system.

### BRIEF DESCRIPTION OF THE DRAWINGS

FIG. 1 is an exemplary view showing the basic arrangement of a memory system according to the first embodiment;

FIG. 2 is a view showing the procedure of an operation in which the memory system according to the first embodiment switches from a normal state to a standby state and returns from the standby state to the normal state;

FIG. 3 is an exemplary view showing the basic arrangement of a memory system according to a comparative example;

FIG. 4 is a view showing the procedure of an operation in which the memory system according to the comparative example switches from the normal state to the standby state and returns from the standby state to the normal state;

FIG. 5 is an exemplary view showing the basic arrangement of a memory system according to the second embodiment;

FIG. 6 is an exemplary view showing the basic arrangement of a memory system according to the third embodiment; and

FIG. 7 is a view showing the procedure of an operation in which the memory system according to the third embodiment switches from the normal state to the standby state and returns from the standby state to the normal state.

### DETAILED DESCRIPTION

In general, according to one embodiment, a memory system includes a storage unit including a buffer and a nonvolatile first memory, and a first controller which includes a processor and a volatile second memory, and in which the processor controls the storage unit based on data stored in the second memory, and issues a first command when switching from a normal state to a standby state. The memory system also includes a second controller which issues a second command for reading data from the first memory to the buffer, based on the first command, and issues a third command for reading the data from the buffer and storing the data in the second memory, when the first controller switches from the standby state to the normal state.

Embodiments will be explained in detail below with reference to the accompanying drawings. Note that in the following explanation, the same reference numbers denote constituent elements having almost the same functions and arrangements, and a repeated explanation will be given only when necessary. Note also that each embodiment to be explained below exemplarily discloses an apparatus and/or method for embodying the technical concept of the embodiment, and the technical concept of the embodiment does not specify the materials, shapes, structures, layouts, and the like of components to those described below. The technical concept of the embodiment can variously be changed within the scope of the appended claims.

### First Embodiment

### <1.1 Arrangement of Memory System>

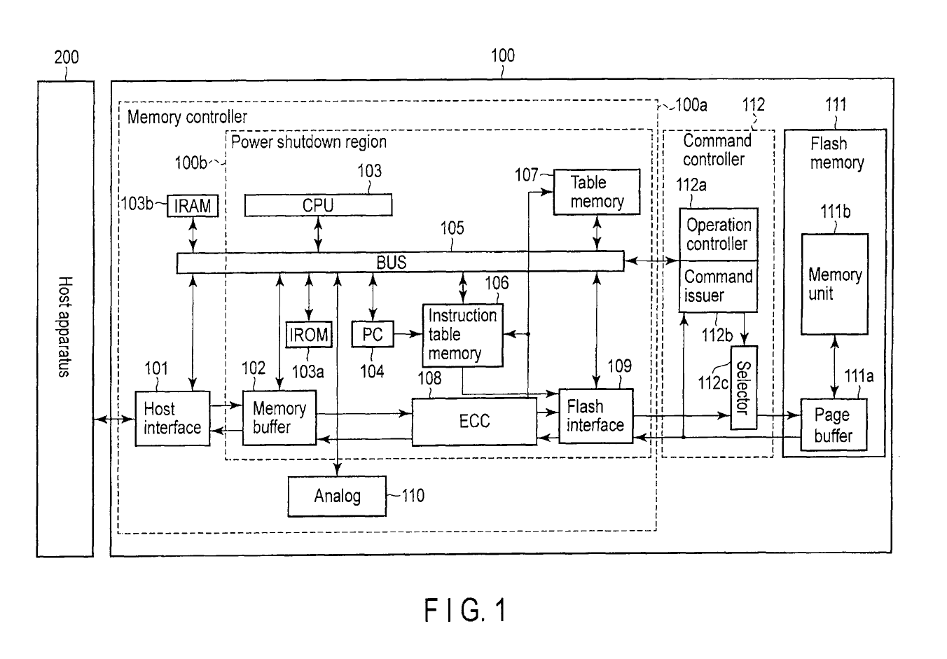

An outline of the basic arrangement of a memory system 100 according to this embodiment will be explained below with reference to FIG. 1.

As shown in FIG. 1, the memory system 100 includes a memory controller 100a, the NAND flash memory (simply referred to as a flash memory) 111, and command controller 112.

The memory controller 100a includes a central processing unit (CPU) 103, a volatile instruction table memory 106, and a firmware table memory 107 (also simply called a volatile memory hereinafter when it is unnecessary to distinguish between the instruction table memory 106 and the firmware table memory). The CPU 103 controls the flash memory 111 based on data (an instruction or control program) stored in the volatile memory. When switching a normal state to a standby state, the CPU 103 issues a first command.

The memory controller 100a includes a host interface 101, a memory buffer 102, the CPU 103, a program counter (PC) 104, a bus 105, the instruction table memory 106, the firmware table memory 107, an error correcting code (ECC) circuit 108, a flash interface 109, and an analog circuit 110.

The command controller 112 includes an operation controller 112a, a command issuer 112b, and a selector 112c.

The host interface 101 is connected to a host apparatus (external apparatus) 200 such as a personal computer, and also connected to the bus 105. The host apparatus 200 and memory system 100 exchange data and the like via the host interface 101.

The memory buffer 102 is connected to the host interface 101 and also connected to the bus 105. The memory buffer 102 receives data transmitted from the host apparatus 200 to the memory system 100 via the host interface 101, and temporarily holds the received data. Also, the memory buffer 102 temporarily holds data to be transmitted from the memory system 100 to the host apparatus 200 via the host interface 101.

The CPU 103 controls the operation of the whole memory system 100. The CPU 103 reads a control program (instruction code) stored in an instruction ROM (IROM) 103a or an instruction RAM (TRAM) 103b via the bus 105, and executes predetermined processing based on the instruction code by decoding it. For example, the CPU 103 executes predetermined processing on the flash memory 111 based a command received from the host apparatus 200 in accordance with a control program.

The IROM 103a is a nonvolatile memory, and the IRAM 103b is the volatile memory. Each memory stores a pure operation program (instruction code for the CPU 103) required for the CPU to operate.

The program counter 104 is connected to the bus 105 and instruction table memory 106. The program counter 104 holds an address in the instruction table memory 106 at which an instruction to be fetched (executed) next is stored. When hardware (not shown) fetches the instruction, the program counter 104 designates an address in the memory at which the next instruction is stored.

The instruction table memory 106 is, e.g., a volatile memory, and stores an instruction code for accessing the flash memory 111 and the like. Also, the instruction table memory 106 supplies an instruction at an address designated by the program counter 104 to the CPU 103 via the bus 105. The instruction table memory 106 holds a coded sequence (instruction code) necessary to access the flash memory 111. The CPU 103 can successively access the flash memory by only presetting an instruction code in the instruction table memory 106, and setting the PC.

The firmware table memory 107 is connected to the bus 105. The firmware table memory 107 is, e.g., a volatile memory, and holds a control program to be executed by the CPU 103 and the like. More specifically, the firmware table memory 107 is used as a temporary work buffer of the CPU 103. For example, the firmware table memory 107 is used to form an information table for converting a logical address to be accessed from the host apparatus 200 into a physical address, or temporarily hold use information of the firmware as a temporary buffer.

Note that data to be held in the instruction table memory 106 and firmware table memory 107 are stored in the flash memory 111. For example, after power is supplied to the memory system 100, various kinds of data are read from the flash memory 111 and supplied to the instruction table memory 106 and firmware table memory 107 in accordance with a READ command issued by the CPU 103.

Note also that in this embodiment, the instruction table memory 106, firmware table memory 107, and the like will collectively simply be called a volatile memory in some cases.

The ECC circuit 108 is connected to the memory buffer 102, instruction table memory 106, and firmware table memory 107. The ECC circuit 108 receives write data from the host apparatus 200 via the memory buffer 102, adds an error correcting code to the write data, and supplies the write data having the error correcting code to, e.g., the memory buffer 102 or flash interface 109. Also, the ECC circuit 108 receives data supplied from the flash memory 111 via the flash interface 109, performs error correction on the data by using an error correcting code, and supplies the error-corrected code to, e.g., the memory buffer 102, instruction table memory 106, or firmware table memory 107.

The flash interface 109 is connected to the ECC circuit 108, bus 105, and instruction table memory 106.

The analog circuit 110 includes an oscillator and power supply unit, and supplies a clock and power to the memory system 100 via the bus 105 or the like. It is also possible to properly change a power supply target region.

The flash memory 111 includes a page buffer 111a and memory unit 111b. The page buffer 111a reads data from the memory unit 111b and temporality holds the data, based on a command supplied from the memory controller 100a. The page buffer 111a then supplies the data to the memory controller 100a via the flash interface 109 or the like. The memory unit 111b includes a plurality of bit lines, a plurality of word lines, and a common source line. The memory unit 111b is a memory cell array in which electrically programmable memory cells such as EEPROM cells are arranged in a matrix.

Note that a NAND flash memory is used as the nonvolatile semiconductor memory 111 in this embodiment, but the present embodiment is not limited to this.

When the memory system 100 switches from a normal state to a standby state, the command controller 112 issues a second command for reading data from the memory unit 111b to the page buffer 111a, based on a first command issued from the CPU 103. When the memory controller 100a switches from the standby state to the normal state, the command controller 112 issues a third command for reading data from the page buffer 111a and storing the data in the instruction table memory 106 and firmware table memory 107.

The command controller 112 includes the operation controller 112a, command issuer 112b, and selector 112c.

The operation controller 112a and command issuer 112b are connected to the bus 105. The operation controller 112a controls the command issuer 112b and selector 112c. The command issuer 112b issues a command to the flash memory 111.

The selector 112c is connected to the flash interface 109. The selector 112c switches the connection between the flash memory 111 and flash interface 109 and the connection between the flash memory 111 and command issuer 112b, based on designation from the operation controller 112a.

When, for example, the host apparatus 200 has not accessed the memory system 100 according to this embodiment for a predetermined time or more, the memory system 100 partially shuts down power (this shutdown will be referred to as partial power shutdown) and switches to the standby state, in order to reduce the power consumption. A partial power shutdown target region (referred to as a power shutdown region 100b) is a region except for a region for receiving a command from the host apparatus 200. More specifically, the power shutdown region 100b of this embodiment includes the memory buffer 102, CPU 103, IROM 103a, program counter 104, bus 105, instruction table memory 106, firmware table memory 107, ECC circuit 108, and flash interface 109 shown in FIG. 1.

When the instruction table memory 106 and firmware table memory 107 as volatile memories are set as partial power shutdown targets, the instruction table memory 106 and firmware table memory 107 are initialized. In a restore operation after partial power shutdown, therefore, data (e.g., an instruction and control program) must be read from the flash memory 111 and stored in the instruction table memory 106 and firmware table memory 107.

Note that data (e.g., an instruction and control program) to be stored in the instruction table memory 106 and firmware table memory 107 are data associated with a basic instruction set, e.g., data necessary to control the flash memory 111, or data necessary for the basic operation of the memory system 100. If this data associated with the basic instruction set is not stored in the volatile memory, the memory system 100 cannot respond to a command request from the host apparatus 200.

The memory unit 111b holds this data (e.g., an instruction and control program) associated with the basic instruction set. The memory unit 111b also holds instruction sets unique to various processes different from the basic instruction set.

<1.2 Operation from Partial Power Shutdown Process to Restoration Process>

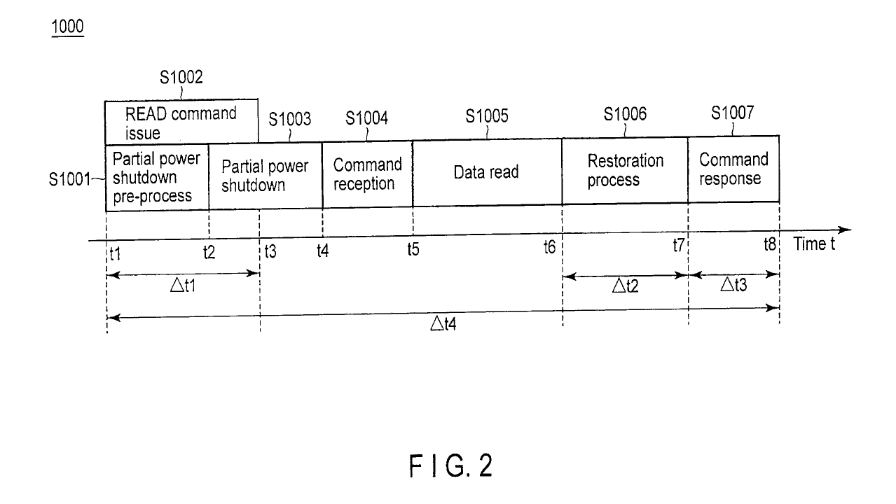

An operation 1000 from a partial power shutdown process to a restoration process of the memory system 100 according to this embodiment will be explained below with reference to FIG. 2. FIG. 2 is a view showing the procedure of the operation 1000 from the partial power shutdown process to the restoration process of the memory system 100 according to this embodiment.

When there is no access from the host apparatus 200, the CPU 103 counts clocks of the analog circuit 110. If a predetermined count (that is appropriately changeable) has been reached, the CPU 103 issues a partial power shutdown command for switching the memory system 100 to the standby state.

At time t1, if a control program (firmware) currently being executed issues a partial power shutdown command, the CPU 103 performs a pre-process for entering the standby state (step S1001). In this pre-process, information required to be saved, among information in a volatile storage area as a power shutdown target, is stored in, e.g., a volatile storage area that is not a power shutdown target, or in a nonvolatile storage area (e.g., the memory unit 111b).

When receiving the partial power shutdown command, the command controller 112 issues a first READ command to the flash memory 111 (step S1002). More specifically, when receiving the partial power shutdown command, the operation controller 112a causes the selector 112c to switch the connection of the flash memory 111 from the flash interface 109 to the command issuer 112b. In addition, the command controller 112a causes the command issuer 112b to issue the first READ command. In response to this command, the flash memory 111 reads data necessary for the volatile memory after restoration from standby, from the memory unit 111b to the page buffer 111a.

When the pre-process is compete at time t2, the CPU 103 causes the analog circuit 110 to shut down power to the power shutdown region 100b. The memory system 100 is set in the standby state until the host apparatus 200 accesses the memory system 100 (step S1003). In the standby state, the flash memory 111 continues the operation of reading data from the memory unit 111b to the page buffer 111a. A time (from time t1 to time t3) Δt1 from the issue of the first READ command to the completion of the read operation to the page buffer 111a will be called, e.g., a read busy time.

At time t4, when the host interface 101 receives a new command from the host apparatus 200 and the memory system 100 is required to return from the standby state to the restoration state, the analog circuit 110 supplies power to the power shutdown region 100b. Then, the command controller 112 issues a command for reading data from the flash memory 111 to the volatile memory. More specifically, when receiving the command from the host apparatus 200, the operation controller 112a causes the command issuer 112b to issue a second READ command for reading the data held in the page buffer 111a to the volatile memory (step S1004).

At time t5, based on the second READ command issued by the command issuer 112b, the page buffer 111a supplies the data to, e.g., the instruction table memory 106 and firmware table memory 107 via the flash interface 109 (step S1005). This process is part of the restoration process.

At time t6, after the data is stored in the instruction table memory 106 and firmware table memory 107, the CPU 103 performs the rest of the restoration process except for the storage of the data in the instruction table memory 106 and firmware table memory 106 (step S1006).

Note that steps S1005 (data read) and S1006 (other restore operations) will collectively be called a restoration process.

At time t7, after the restoration process is complete, the CPU 103 can respond to a command from the host apparatus 200 (step S1007). After the restoration process is complete, the operation controller 112a causes the selector 112c to switch the connection of the flash memory 111 from the command issuer 112b to the flash interface 109.

Note that a time (from time t1 to time t8) required for the memory system 100 to switch from the normal state to the standby state and return from the standby state to the normal state is a time Δt4.

### <1.3 Effect of This Embodiment>

In the embodiment described above, the memory system 100 includes the storage unit (flash memory) 111 including the buffer (page buffer) 111a and nonvolatile first memory (memory unit) 111b, and the first controller (memory controller) 100a which includes the processor (CPU) 103 and volatile second memories (instruction table memory and table memory) 106 and 107, and in which the processor 103 controls the storage unit 111 based on data stored in the second memories 106 and 107, and issues the first command when switching the normal state to the standby state. The memory system 100 also includes the second controller (command controller) 112 that issues the second command for reading data from the first memory 111b to the buffer 111a based on the first command, and the third command for reading data from the buffer 111a and storing the data in the second memories 106 and 107 when the first controller 100a switches from the standby state to the normal state. The first controller 100a further includes the power supply unit (analog) 110 for supplying power to the second memories 106 and 107. The power supply unit 110 stops power supply to the second memories 106 and 107 when the first controller 100a switches from the normal state to the standby state, and resumes power supply to the second memories 106 and 107 when the first controller 100a switches from the standby state to the normal state.

In this embodiment as described above, the read busy time can be shortened because the first READ command can be issued and data stored in the memory unit 111b can be stored in the page buffer 111a during the pre-process and standby state. This makes it possible to shorten the time from the standby state to the restoration of the memory system 100.

The effect of this embodiment will be explained in more detail below by using a comparative example.

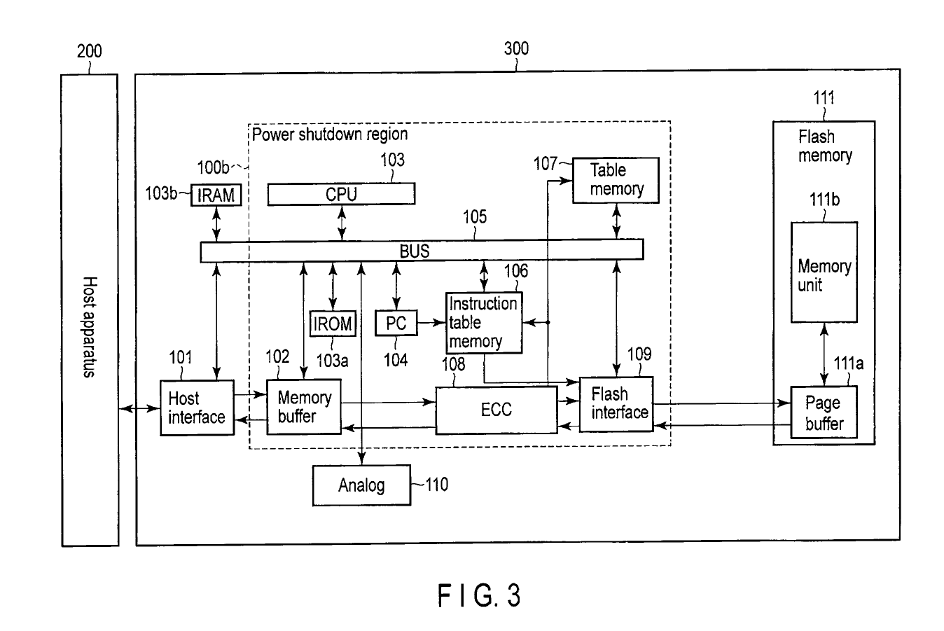

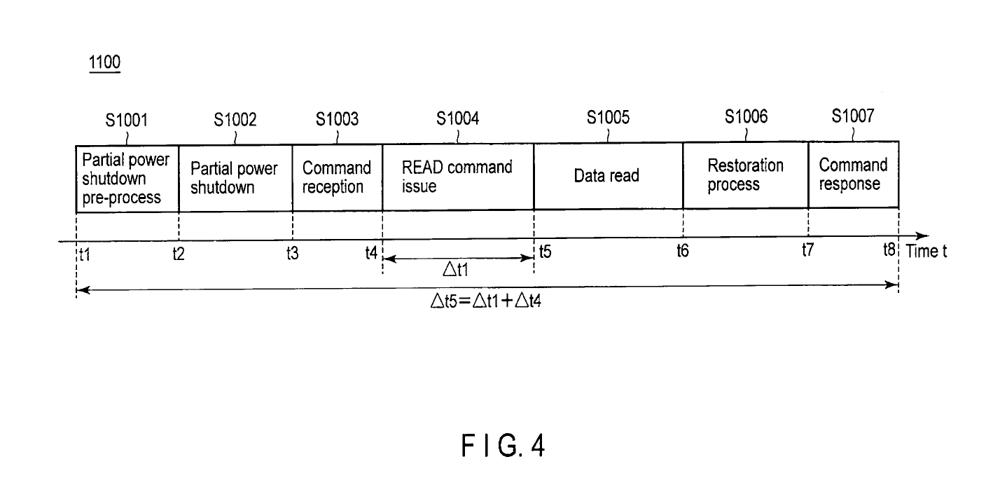

A memory system 300 according to the comparative example will be explained below with reference to FIGS. 3 and 4. FIG. 3 is a block diagram showing the basic arrangement of the memory system 300 according to the comparative example. FIG. 4 is a view showing the procedure of an operation 1100 from a partial power shutdown process to a restoration process of the memory system 300 according to the comparative example.

As shown in FIG. 3, the memory system 300 according to the comparative example differs from the memory system 100 according to this embodiment in that no command controller 112 is formed. Also, the memory system 300 is the same as the memory system 100 in that a region including an instruction table memory 106 and firmware table memory 107 is a power shutdown region 100b. In a restore operation after partial power shutdown, therefore, it is necessary to read data from a flash memory 111 and store the data in the instruction table memory 106 and firmware table memory 107.

As shown in FIG. 4, the memory system 300 has no command controller 112, and hence can neither issue a first READ command nor read the contents of a memory unit 111b to a page buffer 111a during the pre-process (step S1001) and the standby state (step S1002). Accordingly, after a request command is received from a host apparatus 200 (step S1003), a CPU 103 issues a READ command to the flash memory 111 (step S1104), and stores data from the flash memory 111 to the volatile memory (step S1005). After that, it is possible to perform the rest of the restoration process (step S1006), and respond to a command from the host apparatus 200 (step S1007).

In the memory system 300 as described above, a READ command is issued to the flash memory 111 when returning from the standby state. When compared to the memory system 100, therefore, a time (from time t1 to time t8) required to switch the normal state to the standby state and return to the normal state from the standby state is a time Δt5 (Δt5=Δt4+Δt1). The read busy time Δt1 for read from the memory unit 111b to the page buffer 111a is generally a very long time. When a READ command for read from the memory unit 111b to the volatile memory is issued during the return from the standby state, a response from the memory system 300 to a command from the host apparatus 200 is largely delayed, and the access performance worsens.

As described previously, therefore, this embodiment further includes the command controller 112 for issuing a command to the flash memory 111. During the pre-process and the standby state (partial power shutdown), the command controller 112 issues the first READ command to the flash memory 111, before the restoration of the memory system 100. This makes it possible to further shorten the time before the power of the memory system 100 is restored, when a command is received from the host apparatus 200 while the memory system 100 is in the standby state. It is also possible to improve the access performance while reducing the power consumption, because the power to many regions including the volatile memory can be shut down.

### Second Embodiment

The second embodiment will now be explained below. The second embodiment differs from the first embodiment in that an operation controller 112a further includes a register controller 112d, and data is directly stored in a general-purpose register 109a in a flash interface 109 from a flash memory 111 via the register controller 112d. Note that in the second embodiment, the same reference numbers as in the above-described first embodiment denote constituent elements having almost the same functions and arrangements, and a repeated explanation will be given only when necessary.

### <2.1 Arrangement of Memory System>

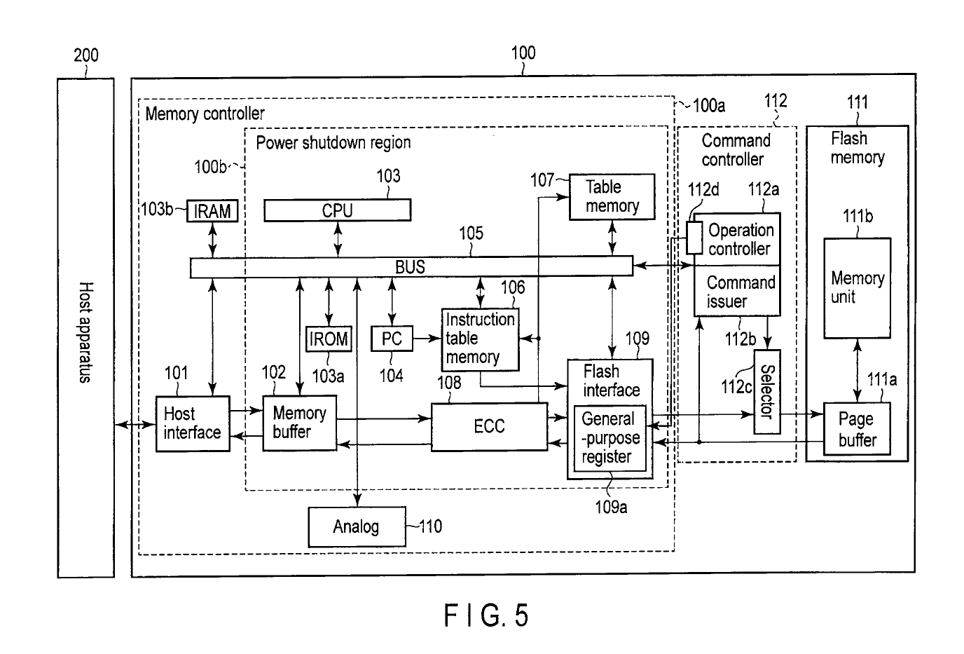

The basic arrangement of a memory system 100 according to the second embodiment will be explained below with reference to FIG. 5.

The flash interface 109 includes the general-purpose register 109a that is a volatile memory for storing, e.g., the settings of the flash interface 109.

The operation controller 112a includes the register controller 112d for storing data in the general-purpose register 109a.

Generally, a CPU 103 stores data in the general-purpose register 109a. More specifically, the CPU 103 reads data stored in, e.g., a firmware table memory 107, and stores the data in the general-purpose register 109a (this is also called, e.g., register setting). This is so because addresses and the like of the general-purpose register 109a are complicated, so it is difficult to directly store data in the general-purpose register 109a from the flash memory 111. The register controller 112d receives data to be stored in the general-purpose register 109a from the flash memory 111, associates an internal address of the general-purpose register 109a with the data, and stores the data in the general-purpose register 109a.

Note that although details will not be explained in this embodiment, the register controller 112d may also store data in another general-purpose register (not shown) in which the CPU 103 generally stores data.

<2.2 Operation from Partial Power Shutdown Process to Restoration Process>

An operation from a partial power shutdown process to a restoration process of the memory system 100 according to the second embodiment will be explained below.

Steps S1001 to S1004 and S1007 are the same as those described previously.

After steps S1001 to S1004 described above, a page buffer 111a supplies data to a volatile memory via the flash interface 109, based on a second READ command issued by a command issuer 112b (a corresponding step is step S1005). In this step, data to be stored in the general-purpose register 109a is supplied to the register controller 112d. The register controller 112d adds an internal address of the general-purpose register 109a to the data, and stores the data in the general-purpose register 109a.

After data is stored in, e.g., an instruction table memory 106 and the firmware table memory 107, the CPU 103 performs the rest of the restoration process (a corresponding step is step S1006). In this step, the CPU 103 need not perform a process of reading data from the firmware table memory 107 and storing the data in the general-purpose register 109a, the restoration processing time of the CPU 103 can be shortened. A time required for the rest of the restoration process is a time Δt6 (<Δt2 [the time required for step S1006 of the first embodiment]).

Note that a time required for the memory system 100 to switch from the normal state to the standby state and return from the standby state to the normal state is a time Δt7 (<Δt4 [the time required for the operation 1000 of the first embodiment]).

### <2.3 Effect of This Embodiment>

In the above-described embodiment, the second memories (instruction table memory and firmware table memory) 106 and 107 include the register (general-purpose register) 109a, and a second controller (command controller) 112 includes the third controller (register controller) 112d. When a first controller (memory controller) 100a switches from the standby state to the normal state, the third controller 112d receives data read from the buffer 111a, and stores the received data in the register 109a.

As described above, data associated with the general-purpose register 109a can be stored in it without using the CPU 103, by supplying the data to the register controller 112d. This makes it possible to further shorten the restoration processing time of the CPU 103. Consequently, the access performance of the memory system 100 can be further improved.

### Third Embodiment

Next, the third embodiment will be explained. The third embodiment differs from the first embodiment in that a command to be requested next from a host apparatus 200 is predicted while performing a pre-process, and the predicted command is issued to a flash memory. Note that in the third embodiment, the same reference numbers as in the above-described first embodiment denote constituent elements having almost the same functions and arrangements, and a repeated explanation will be given only when necessary.

### <3.1 Arrangement of Memory System>

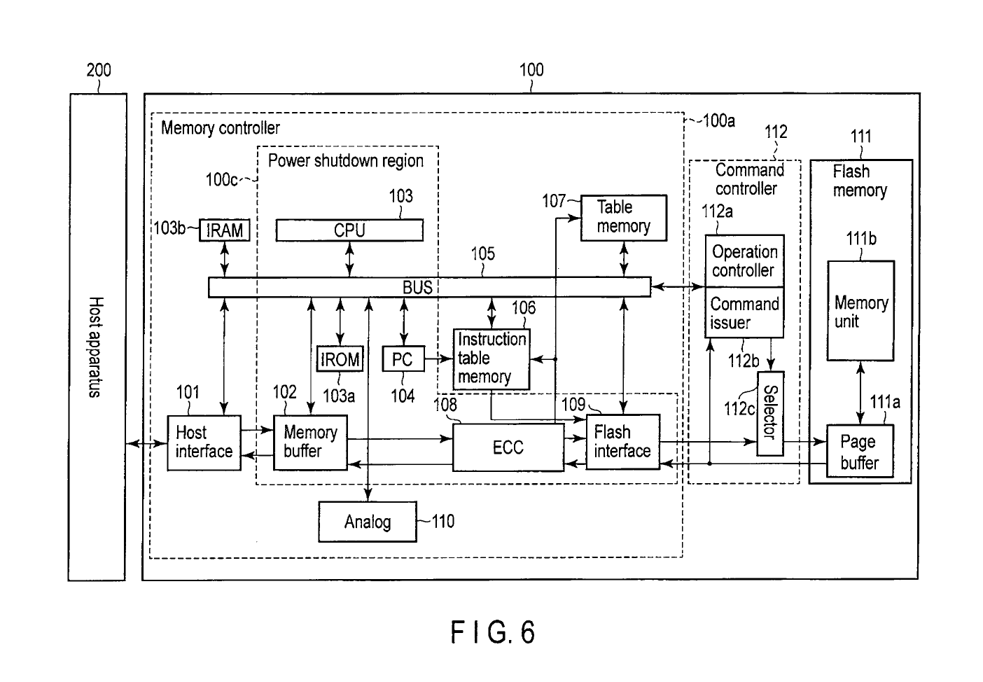

The basic arrangement of a memory system 100 according to the third embodiment will be explained below with reference to FIG. 6.

In this embodiment as shown in FIG. 6, a power shutdown region 100c includes a memory buffer 102, CPU 103, IROM 103a, program counter 104, bus 105, ECC circuit 108, and flash interface 109.

In this embodiment, an instruction table memory 106 and firmware table memory 107 as volatile memories are not partial power shutdown targets. Even when the memory system 100 is in the standby state, therefore, the instruction table memory 106 and firmware table memory 107 are not initialized, so no read operation need be performed for a flash memory 111 in a restore operation after partial power shutdown. This is so because even when the memory system 100 is in the standby state, data associated with a basic instruction set explained in the first embodiment is maintained in the volatile memories.

Also, in this embodiment, an operation controller 112a holds only a predetermined number of commands (at least an immediately preceding command) supplied from the host apparatus 200 to a memory controller 100a. When detecting a partial power shutdown command, the operation controller 112a predicts a command to be requested by the host apparatus 200 after restoration, based on the held commands. For example, if a command requested for the memory system 100 by the host apparatus 200 immediately before power shutdown is one of a plurality of consecutive commands having regularity, the operation controller 112a can empirically predict a command to be requested next by the host apparatus 200.

<3.2 Operation from Partial Power Shutdown Process to Restoration Process>

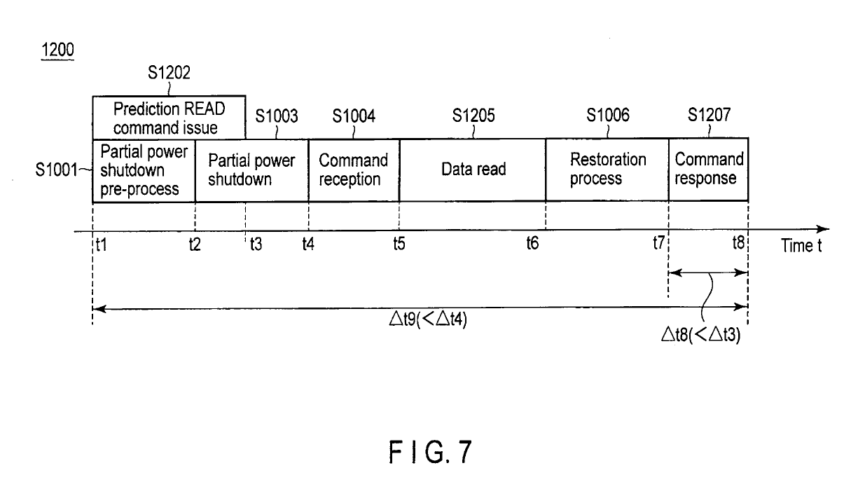

An operation 1200 from a partial power shutdown process to a restoration process of the memory system 100 according to the third embodiment will be explained below with reference to FIG. 7. FIG. 7 is a view showing the procedure of the operation 1200 from the partial power shutdown process to the restoration process of the memory system 100 according to this embodiment.

Steps S1001 to S1004 and S1006 are the same as those described previously.

At time t1, when detecting a partial power shutdown command, a command controller 112 predicts the next command to be requested by the host apparatus 200, and issues a READ command (also referred to as a prediction READ command) for reading the predicted command to the flash memory 111 (step S1202).

More specifically, the operation controller 112a causes a command issuer 112b to issue a prediction READ command for reading data necessary for the predicted command from a memory unit 111b to a page buffer 111a. While the memory system 100 is in the standby state, the flash memory 111 receives the prediction READ command from the command controller 112, and performs an operation of reading data from the memory unit 111b to the page buffer 111a. A time required from the issue of this prediction READ command to the completion of the read operation for the page buffer 111a is called, e.g., a read busy time.

At time t5, based on a second READ command issued by the command issuer 112b, the page buffer 111a supplies the predicted command to the instruction table memory 106 and firmware table memory 107 via the flash interface 109 (step S1205).

At time t7, after the restoration process is complete, the CPU 103 can respond to a command from the host apparatus 200 (step S1207). If the command requested by the host apparatus 200 matches the command predicted by the operation controller 112a, the CPU 103 can immediately respond. When compared to an operation in which a command to be requested by the host is not predicted, therefore, a response time Δt8 (<Δt3 [the time required for step S1007]) can be shortened.

Note that a time (from time t1 to time t8) required for the memory system 100 to switch from the normal state to the standby state and return from the standby state to the normal state is a time Δt9 (<Δt4 [the time required for the operation 1000]).

### <3.3 Effect of This Embodiment>

In the memory system 100 according to the above-described embodiment, when the first controller (memory controller) 100a is in the standby state, the second memories (instruction table memory and table memory) 106 and 107 hold data to be used to control the storage unit (flash memory) 111, and the second controller (command controller) 112 selects data to be read from the first memory (memory unit) 111b, based on the second command. Based on commands supplied by the host apparatus 200 before the first controller 100a switches to the standby state, the second controller 112 predicts a command to be executed after the first controller 100a switches from the standby state to the normally state, and issues the second command based on the predicted command.

By thus reading a predicted command beforehand, it is possible to further improve the access performance of the memory system 100 when the host apparatus 200 requests a command having regularity.

### <Modifications>

Note that the power shutdown regions 100b and 100c have been explained as partial power shutdown regions, but the present embodiment is not limited to this. The power shutdown region can appropriately be changed unless power to a minimum necessary circuit for responding to access from the host apparatus 200 is shut down. For example, the analog circuit 110 may also be a power shutdown target.

Note also that steps S1002 and S1202 explained above are executed over steps S1001 and S1003, but the present embodiment is not limited to this. Steps S1002 and 1202 may also be executed over steps S1001, S1003, and S1004, and need not be executed over steps S1001 and S1003.

Furthermore, in each of the above-described embodiments, the command issuer 112b issues a READ command for reading data from the volatile memory, or a predicted command, but the present embodiment is not limited to this. The command issuer 112b can appropriately change commands to be issued.

It is also possible to apply the memory system 100 explained in each embodiment to a semiconductor memory such as a memory card, memory device, or internal memory, provided that the memory operates in the same manner as above, and achieve the same effect as that of each of the above-described embodiments. The memory controller 100a and command controller 112 explained in each embodiment can also be formed on the same chip, and the memory controller 100a, command controller 112, and flash memory 111 can also be formed on the same chip.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a storage unit including a buffer and a nonvolatile first memory;
a first controller including a processor and a volatile second memory, the processor controlling the storage unit based on data stored in the second memory, and issuing a first command when switching from a normal state to a standby state; and
a second controller configured to issue a second command for reading data from the first memory to the buffer, based on the first command, and issue a third command for reading the data from the buffer and storing the data in the second memory, when the first controller switches from the standby state to the normal state.

2. The system according to claim 1, wherein
the first controller further comprises a power supply unit configured to supply power to the second memory, and
the power supply unit stops power supply to the second memory when the first controller switches from the normal state to the standby state, and resumes power supply to the second memory when the first controller switches from the standby state to the normal state.

3. The system according to claim 1, wherein
the second memory includes a register,
the second controller includes a third controller, and
the third controller receives the data read from the buffer and stores the received data in the register, when the first controller switches from the standby state to the normal state.

4. The system according to claim 1, wherein
when the first controller is in the standby state, the second memory holds data to be used to control the storage unit, and
the second controller selects data to be read from the first memory, based on the second command.

5. The system according to claim 4, wherein
the second controller predicts a command to be executed after the first controller switches from the standby state to the normal state, based on a command supplied from a host apparatus before the first controller switches to the standby state, and
issues the second command based on the predicted command.

6. The system according to claim 5, wherein
the second controller holds a predetermined number of commands supplied from the host apparatus,
predicts a command to be executed after the first controller switches from the standby state to the normal state, based on the held commands, and
issues the second command based on the predicted command.

7. The system according to claim 1, wherein
the second controller comprises:
a command issuer configured to issue the second command and a third command;
a selector configured to switch a connection between the buffer and the second memory and a connection between the buffer and the command issuer; and
a fourth controller configured to control the command issuer and the selector,
when receiving the first command,
the fourth controller causes the selector to switch the connection between the buffer and the second memory to the connection between the buffer and the command issuer, and
causes the command issuer to issue the second command to the buffer, and
when the first controller switches from the standby state to the normal state,
the fourth controller causes the command issuer to issue the third command to the buffer.

8. The system according to claim 1, wherein when issuing the first command, the first controller causes the first memory to store information which must be saved among information in the second memory as a power shutdown target.

9. The system according to claim 7, wherein after the first controller switches from the standby state to the normal state, the fourth controller causes the selector to switch the connection of the buffer from the command issuer to the second memory.

10. The system according to claim 1, wherein the second memory is one of an instruction table memory and a firmware table memory.

11. A control method of a memory system comprising:
a storage unit including a buffer and a nonvolatile first memory;
a first controller including a processor and a volatile second memory, the processor controlling the storage unit based on data stored in the second memory; and
a second controller electrically connected to the storage unit and the first controller,
the method comprising:
causing the first controller to issue a first command for switching a normal state to a standby state;
causing the first controller to perform a preparation for entering the standby state, based on the first command;
causing the second controller to issue a second command for causing the storage unit to read data from the first memory to the buffer, based on the first command;
causing, after the preparation is complete, the first controller to shut down power to a predetermined region and switch from the normal state to the standby state;
causing the storage unit to read data from the first memory to the buffer, during the preparation or the standby state; and
causing, when receiving a third command from a host apparatus, the first controller to perform a restore operation for supplying power to the predetermined region and returning from the standby state to the normal state.

12. The method according to claim 11, wherein the preparation comprises causing the first memory to store data pertaining to an operation of the processor, among data in the second memory as a power shutdown target.

13. The method according to claim 11, wherein the restore operation comprises:
issuing, to the buffer, a fourth command for reading data from the buffer to the second memory, based on the third command; and
supplying data from the buffer to the second memory based on the third command.

14. The method according to claim 11, wherein the causing the second controller to issue the second command comprises predicting a command to be executed after the first controller switches from the standby state to the normal state, based on a command supplied from the host apparatus before switching to the standby state, and issuing the second command based on the predicted command.
